(19) United States
(12) Patent Application Publication
(10) Pub. No.: US 2009/0294564 A1
(43) Pub. Date: Dec. 3, 2009

(54) REEL AND REEL MANUFACTURING METHOD

(75) Inventor: Kazuo KUBOTA, Kanagawa (JP)

Correspondence Address: Moss & Burke, PLLC, 401 Holland Lane, Suite 407, Alexandria, VA, 22314, US

(73) Assignee: FUJIFILM CORPORATION, Tokyo (JP)

(21) Appl. No.: 12/474,283

(22) Filed: May 29, 2009

(30) Foreign Application Priority Data
Jun. 3, 2008 (JP) 2008-145968

(51) Int. Cl. G11B 23/107; G11B 23/113; B65H 23/00

(52) U.S. Cl. 242/348; 242/548

(57) ABSTRACT

A tape and reel combination and tape and reel combination manufacturing method are provided that can prevent edge-folding occurring to edges of a recording tape that has been wound on a hub. In a reel having a hub on which recording tape is wound, a first flange provided at a one end of the hub, and a second flange provided at the other end of the hub, at the reel radial direction outside of the recording tape T wound on the hub, a first region and a second region are formed, as specific regions, in sequence from the radial direction inner side of the first region. In the first region the recording tape is positioned offset toward the first flange side, and in the second region the recording tape is positioned offset toward the second flange side.

### CROSS-REFERENCE TO RELATED APPLICATION

This application claims priority under 35 USC 119 from Japanese Patent Application No. 2008-145968 filed on Jun. 3, 2008, the disclosure of which is incorporated by reference herein.

### BACKGROUND OF THE INVENTION

1. Technical Field

The present invention relates to a tape and reel combination in which a reel with a hub wound with recording tape thereon, such as magnetic tape, and to a manufacturing method thereof.

2. Related Art

Reels are known having a hub of bottomed circular cylinder shape, provided with an upper flange at a top end portion thereof, and a lower flange at a bottom end portion thereof, wound with recording tape thereon, such as magnetic tape. Such a reel is, for example, described in Japanese Patent Application Laid-Open (JP-A) No. 11-306714. Sometimes with such reels a phenomenon occurs in which one layer (or plural layers) of the recording tape wound on the hub sticks out from the winding face toward the top or bottom (in the hub axial direction).

### SUMMARY

If the upper flange or lower flange warps due to impact when being transported or dropped, then the edge of the recording tape that sticks out toward the top or bottom contacts the upper flange or the lower flange, and this sometimes leads to the sticking out edge of the recording tape being folded over. If the edge of the recording tape is folded over, then this may lead to error generation when recording or reproducing data in a drive device.

In consideration of the above circumstances, the present invention provides a reel such that edge-folding of recording tape wound on a hub is prevented, and a manufacturing method thereof.

A first aspect of the present invention is a tape and reel combination including: a hub on which recording tape is wound; a recording tape being wound on the hub; a first flange provided at one end of the hub; and a second flange provided at another end of the hub, wherein a specific region of the recording tape wound on the hub, at the outside in the reel radial direction, is formed with a first region and a second region in sequence from the radial direction inner side of the specific region, and the recording tape is wound in the first region positioned offset toward the first flange side, and the recording tape is wound in the second region positioned offset toward the second flange side.

According to the tape and reel combination of the first aspect, the first region and the second region are formed at the reel radial direction outside of the recording tape wound on the hub. In the first region, the recording tape is wound positioned offset toward the first flange side, and in the second region, the recording tape is wound positioned offset toward the second flange side. Hence, warping of the first flange and the second flange can be suppressed by the first region and the second region even when an impact is imparted to the reel, such as due to dropping. Consequently even in cases, for example, of recording tape with irregular winding where there is one layer, or plural layers of the recording tape, sticking out from the winding face further inside in the radial direction than the first region, an edge of the sticking out recording tape is prevented from contacting with the first flange or the second flange, and edge-folding of the recording tape is also avoided.

A second aspect of the present invention is the tape and reel combination according to the first aspect, wherein the recording tape is wound in an offset position such that a widthwise edge of the recording tape is positioned immediately adjacent to the hub-side inner face of the first flange in the first region and another widthwise edge of the recording tape is positioned immediately adjacent to the hub-side inner face of the second flange in the second region.

According to the tape and reel combination of the second aspect, even if an impact is imparted to the reel, such as by dropping, warping of the first flange and the second flange can be suppressed by the first region and the second region, the edge of the sticking out recording tape is prevented from contacting with the first flange or the second flange, and edge-folding of the recording tape is also avoided.

A third aspect of the present invention is the tape and reel combination according to the second aspect, wherein the widthwise edge of the recording tape contacts with the hub-side inner face of the first flange in the first region and the another widthwise edge of the recording tape contacts with the hub-side inner face of the second flange in the second region.

According to the tape and reel combination of the third aspect, even if an impact is imparted to the reel, such as by dropping, warping of the first flange and the second flange can be suppressed by the first region and the second region, the edge of the sticking out recording tape is prevented from contacting with the first flange or the second flange, and edge-folding of the recording tape is also avoided.

A fourth aspect of the present invention is a tape and reel combination manufacturing method for a reel with a hub with recording tape thereon, the hub being provided with a first flange at one end thereof and a second flange at another end thereof. The tape and reel combination manufacturing method includes: rotating the hub; after a specific amount of recording tape has been wound on the hub, moving the hub in one direction along the rotation axis direction of the hub, so that the recording tape is positioned offset toward the first flange side, and rotating the hub a specific number of rotations to form a first region; and then moving the hub in the opposite direction along the rotation axis direction, so that the recording tape is positioned offset toward the second flange side, and rotating the hub a specific number of rotations to form a second region.

According to the tape and reel combination manufacturing method of the fourth aspect, the first region and the second region are formed at the reel radial direction outside of the recording tape wound on the hub. In the first region, the recording tape is wound positioned offset toward the first flange side, and in the second region, the recording tape is wound positioned offset toward the second flange side. Hence, warping of the first flange and the second flange can be suppressed by the first region and the second region, even when an impact is imparted to the reel, such as due to dropping. Consequently even in cases, for example, of recording tape with irregular winding where there is one layer, or plural layers of the recording tape, sticking out from the winding face at a position further to the radial direction inside than the first region, an edge of the sticking out recording tape is prevented from contacting with the first flange or the second flange, and edge-folding of the recording tape is also avoided.

A tape and reel combination manufacturing method of a fifth aspect of the present invention is the tape and reel combination manufacturing method of the fourth aspect, wherein when the rigidity of the first flange and the second flange are different from each other, the movement amount of the hub when positioning the recording tape offset toward the smaller rigidity flange side is greater than the movement amount of the hub when positioning the recording tape toward the larger rigidity flange side.

According to the tape and reel combination manufacturing method of the fifth aspect, the movement amount of the recording tape toward the smaller rigidity flange side being insufficient and resulting in the edge of the recording tape not reaching the inner face of the low rigidity flange, can either be suppressed or prevented. Accordingly, the first region and the second region can be accurately formed.

A tape and reel combination manufacturing method of a sixth aspect of the present invention is the tape and reel combination manufacturing method of the fourth aspect or of the fifth aspect, wherein the rotation speeds of the reel when forming the first region and the second region are slower than the rotation speed of the reel prior to forming the first region.

According to the tape and reel combination manufacturing method of the sixth aspect, the first region and the second region can be accurately formed.

A tape and reel combination manufacturing method of a seventh aspect of the present invention is the tape and reel combination manufacturing method of the fourth aspect, wherein the recording tape is wound in an offset position such that a widthwise edge of the recording tape is positioned immediately adjacent to the hub-side inner face of the first flange in the first region and another widthwise edge of the recording tape is positioned immediately adjacent to the hub-side inner face of the second flange in the second region.

According to the seventh aspect, even if an impact is imparted to the reel, such as by dropping, warping of the first flange and the second flange can be suppressed by the first region and the second region, which are positioned immediately adjacent to the hub-side inner face of the first flange and the hub-side inner face of the second flange. Accordingly, an edge of the sticking out recording tape is prevented from contacting with the first flange or the second flange, and edge-folding of the recording tape is also avoided.

A tape and reel combination manufacturing method of an eighth aspect of the present invention is the tape and reel combination manufacturing method of the seventh aspect, wherein the recording tape is wound in an offset position such that the widthwise edge of the recording tape contacts with the hub-side inner face of the first flange in the first region and the another widthwise edge of the recording tape contacts with the hub-side inner face of the second flange in the second region.

According to the tape and reel combination manufacturing method of the eighth aspect, even if an impact is imparted to the reel, such as by dropping, warping of the first flange and the second flange can be suppressed by the first region and the second region, the edge of the sticking out recording tape is prevented from contacting with the first flange or the second flange, and edge-folding of the recording tape is also avoided.

### BRIEF DESCRIPTION OF THE DRAWINGS

Exemplary embodiments of the present invention will be described in detail based on the following figures, wherein:

FIG. 1 is a schematic perspective view of a recording tape cartridge;

FIG. 2 is a schematic configuration diagram of a winding device;

FIG. 3 is a schematic cross sectional diagram of a reel on which recording tape has been wound;

FIG. 4 is a schematic cross sectional diagram of a reel on which recording tape has been wound;

FIG. 5 is an explanatory diagram showing fluctuations in the winding face of recording tape that has been wound on a reel;

FIG. 6A is an explanatory diagram showing fluctuations prior to dropping in the winding face of recording tape wound on a reel; FIG. 6B is an explanatory diagram showing fluctuations after dropping in the winding face of recording tape wound on a reel;

FIG. 7A is an explanatory diagram showing fluctuations prior to dropping in the winding face of recording tape wound on a reel;

FIG. 7B is an explanatory diagram showing fluctuations after dropping of the winding face of recording tape wound on a reel;

FIG. 8 is an explanatory diagram showing states of edge-folding occurrence depending on the winding length of recording tape, configuring a first region and a second region;

FIG. 9 is an explanatory diagram showing a servo-band of recording tape;

FIG. 10 is a graph showing relative rigidity of an upper flange and a lower flange;

FIG. 11 is an explanatory diagram showing fluctuations in the winding face of recording tape wound on a reel;

FIG. 12 is an explanatory diagram showing fluctuations in the winding face of recording tape wound on a reel; and

FIG. 13 is an explanatory diagram showing fluctuations in the winding face of recording tape that has been wound on a reel.

### DETAILED DESCRIPTION OF THE INVENTION

Herebelow, an example of an exemplary embodiment of the present invention will be described in detail with reference to the drawings.

Since the tape and reel combination and the tape and reel combination manufacturing method of the present exemplary embodiment can be preferably applied in cases where a single reel 30 is housed within a case 12, as in a recording tape cartridge 10, explanation will be given using the recording tape cartridge 10. However, there is no limitation thereto and application may be made in a similar manner to reels having upper and lower flanges, such as in cassettes housing a pair of reels within a case.

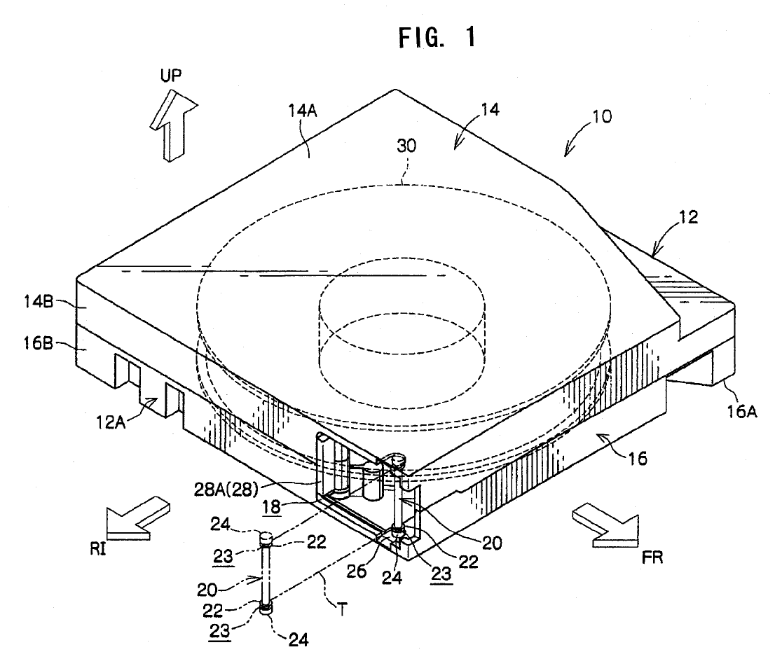

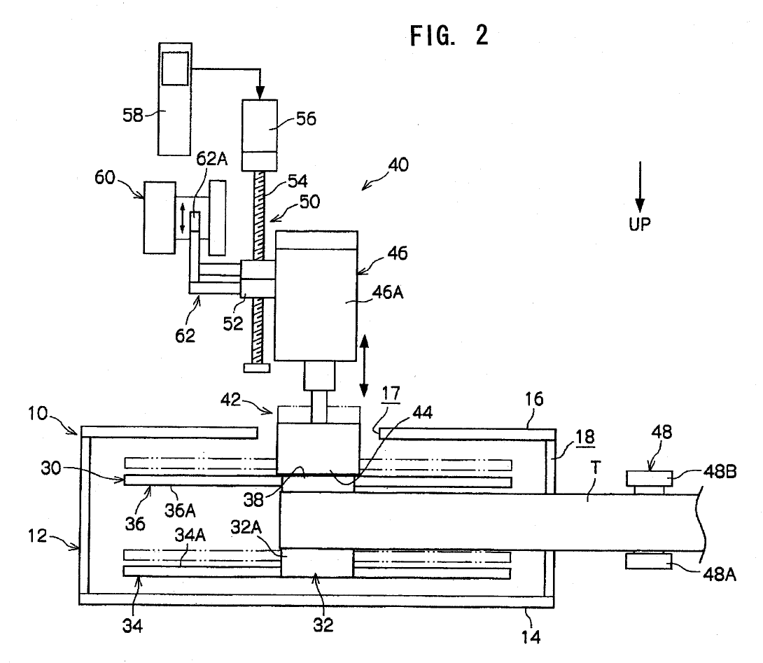

FIG. 1 is a schematic perspective view of the recording tape cartridge 10, and FIG. 2 is a schematic configuration diagram of a winding device 40 for winding recording tape T on a reel hub 32 of the reel 30 that is housed in the recording tape cartridge 10. First a simple explanation will be given regarding the recording tape cartridge 10, and for ease of explanation the arrow FR indicates the front direction, arrow UP the up direction, and the arrow RI the right direction. Namely, in each of the drawings, when arrow FR, arrow UP and arrow RI are shown then the directions based on the arrows will represent front-rear, up-down, and left-right directions respectively.

As shown in FIG. 1, the recording tape cartridge 10 has a substantially rectangular box shaped case 12. The case 12 is configured by an upper case 14 and a lower case 16 made from a resin, respectively, a top panel 14A having a peripheral wall 14B extending down therefrom, and a bottom panel 16A having a peripheral wall 16B extending up therefrom. The peripheral walls 14B, 16B are joined together in an abutting state by screws or the like. A single resin reel 30 is rotatably accommodated within the case 12.

As shown in FIG. 2, the reel 30 is configured with a bottomed circular cylindrical shaped reel hub 32, a lower flange 36 disposed at a bottom end portion thereof, and an upper flange 34 disposed at a top end portion thereof. The reel hub 32 configures the axial central portion of the reel 30. Recording tape T, such as magnetic tape, is wound as an information recording and reproducing medium around an outer peripheral face 32A of the reel hub 32. Both edges in the width direction of the wound recording tape T are held by the upper flange 34 and the lower flange 36. While not shown in the drawings, an inner face 34A of the upper flange 34 and an inner face 36A of the lower flange 36 are configured as tapering surfaces with a separation distance therebetween that widens on progression toward the outer peripheral edge thereof.

A reel gear 38 is formed in a ring shape at the bottom face of a bottom wall of the reel hub 32, and a ring shaped reel plate (not illustrated) of a magnetic material is integrally fixed by inset molding or the like to the bottom face of the reel hub 32 at the radial direction inside of the reel gear 38. A gear opening 17 is formed through a substantially central portion of the lower case 16 for externally exposing the reel gear 38 and the reel plate therethrough (see FIG. 2). The reel gear 38 exposed through the gear opening 17 is meshed with a drive gear (not illustrated) formed to a rotation shaft (not illustrated) of the drive device, and the reel 30 is relatively rotatable in the case 12 with respect to the case 12 by rotational driving of the reel gear 38.

An opening 18, for drawing out the recording tape T wound around the reel 30, is formed in a right wall 12A of the case 12, as shown in FIG. 1. A leader pin 20 is secured to a free end portion of the recording tape T drawn out from the opening 18, while latched (engaged) by a drawing-out member (not illustrated) of the drive device.

Large flanges 24 shaped as thick plates are integrally provided at portions at the two ends in the axial direction of the leader pin 20, and small flanges 22 shaped as thin plates are integrally provided inside of the large flanges 24 in the axial direction, separated by a specific distance. The free end portion of the recording tape T is secured between the small flanges 22, and ring shaped grooves 23 are formed between the small flanges 22 and the large flanges 24, with the drawing-out member of the drive device, such as a hook, engaging with the grooves 23.

A pair of upper and lower pin retaining portions 26 is formed inside the opening 18 of the case 12, namely on an inner face of the top plate 14A and an inner face of the bottom plate 16A, for positioning and retaining the leader pin 20 within the case 12. The pin retaining portions 26 are substantially semicircular in shape and are open to the outside at the drawing-out side of the recording tape T. In an upright state, the leader pin 20 may enter into and exit from the pin retaining portions 26 from the open side.

A leaf spring (not illustrated) is disposed fixed in a vicinity of the pin retaining portions 26. Bifurcate tip end portions of the leaf spring are respectively engaged with the large flanges 24 of the leader pin 20, so as to retain the leader pin 20 in the pin retaining portions 26. When the leader pin 20 enters and exits the pin retaining portions 26, the tip end portions of the leaf spring are elastically deformed by a suitable amount, so as to permit movement of the leader pin 20.

The opening 18 is opened and closed off with a door 28. The door 28 is formed in a substantially rectangular plate shape of such a size as to be able to close off the opening 18, and the door 28 is urged in the direction of closing the opening 18 by a non-illustrated biasing member. A protruding portion 28A is formed protruding outward from a front end portion of the door 28, for opening and closing operations. The protruding portion 28A is engaged with an opening and closing member (not illustrated) of the drive device when the recording tape cartridge 10 is loaded in the drive device, and the door 28 is opened against the urging force of the biasing member.

In the recording tape cartridge 10 configured as described above, as shown in FIG. 2, there are occasions when the reel 30, on which no recording tape T is wound, is assembled within the case 12, and the recording tape cartridge 10 is set in this state to the winding device 40, and recording tape T is wound within the case 12. The free end portion of the recording tape T on the opposite end to which the leader pin 20 is attached is inserted through the opening 18, and after attaching to the outer peripheral face 32A of the reel hub 32, the recording tape T is progressively wound onto the reel hub 32 by rotating the reel hub 32.

Explanation will now be given of the winding device 40 for winding the recording tape T onto the reel hub 32 of the reel 30 assembled within the case 12. A rotation mechanism 42 is provided to the winding device 40, as shown in FIG. 2, for holding and rotating the reel hub 32 of the reel 30, on which no recording tape T is wound, within the case 12. The case 12 is disposed such that the upper flange 34 is at the bottom side and the lower flange 36 is at the top side in FIG. 2.

The rotation mechanism 42 is provided with: a ring shaped rotation drive gear 44 that is meshed with the reel gear 38 formed at a lower surface of the bottom wall of the reel hub 32 and; a magnet (not illustrated) that attracts and holds the reel plate provided at the lower surface of the bottom wall of the reel hub 32 and that rotates together with the rotation drive gear 44; and a rotation drive motor 46 that rotates the rotation drive gear 44. The rotation speed of the rotation drive motor 46 is variable by a means of a non-illustrated control device.

A movement mechanism 50 is also provided to the winding device 40 for moving the rotation drive motor 46 in the axial direction of the reel hub 32. The movement mechanism 50 is provided with: a ball thread 54 onto which is threaded a support member 52 that is fixed to a body 46A of the rotation drive motor 46; a servo motor 56 for rotational driving of the ball thread 54; and a servo unit 58 for controlling the servo motor 56.

The drive device 40 is also provided with a displacement sensor 60 that detects the movement amount (displacement amount) of the rotation drive motor 46. The displacement sensor 60 is configured to be capable of detecting the position of the rotation drive motor 46 in the axial direction of the reel hub 32 which corresponds to the position of the reel 30 within the case 12 by detecting the position of an end portion 62A of a detecting member 62, the end portion 62A being formed in substantially an L-shape extending out from the support member 52.

A guide roller 48 is disposed immediately outside of the case 12, for final guiding of the recording tape T which has been unwound by a non-illustrated unwinding mechanism. The guide roller 48 is fixed so as to rotate freely, and flanges 48A, 48B of a specific thickness are integrally formed thereto at each end in the axial direction thereof.

After attaching the free end portion of the recording tape T to the outer peripheral face 32A of the reel hub 32, the recording tape T is progressively wound onto the outer peripheral face 32A of the reel hub 32 by rotation of the rotation drive motor 46 at a specific speed while restricting (while guiding) the position of the recording tape T in the width direction with the flanges 48A, 48B of the freely rotating guide roller 48.

Explanation will now be given of operation of such a drive device 40 (manufacturing method for winding recording tape T onto the reel 30). As shown in FIG. 2, first the recording tape cartridge 10, housing within the case 12 the reel 30 on which there is no recording tape T wound, is set in the drive device 40. The rotation drive gear 44 is meshed with the reel gear 38, and the reel plate is attracted and held by the magnet. The free end portion of the recording tape T is inserted through the opening 18, and attached to the outer peripheral face 32A of the reel hub 32.

When the free end portion of the recording tape T has been attached to the outer peripheral face 32A of the reel hub 32, the reel hub 32 (reel 30) is rotated at a specific speed by rotation of the rotation drive motor 46 at a specific speed, and the recording tape T is progressively wound onto the reel hub 32 by being unwound from the unwinding mechanism while applying a specific tension, and while finally guiding the position of the recording tape T in the width direction by means of the guide roller 48.

When it is determined by the non-illustrated control device that a specific length of recording tape T has been wound onto the reel hub 32, the servo motor 56 is actuated by the servo unit 58, rotating the ball thread 54. Then the support member 52 that is threaded onto the ball thread 54 moves in the axial direction of the reel hub 32, and the position of the rotation drive motor 46 is displaced in the axial direction of the reel hub 32, with relative displacement of the recording tape T with respect to the reel hub 32 in the width direction (the axial direction) of the reel hub 32.

Namely, for example as shown in the solid lines of FIG. 2, when the reel 30 is moved (displaced) toward the upper case 14 side (downward in the figure), the winding position of the recording tape T is relatively positioned offset toward the lower flange 36 side, and the edge of the recording tape T is wound in a state in which it is immediately adjacent to (just prior to contact with) the inner face 36A of the lower flange 36, or it is slightly in contact therewith. The position of the rotation drive motor 46 at this time is detected by the displacement sensor 60.

Then, while in this state, when it is determined by the non-illustrated control device that a specific length (for example 50 m or more) of the recording tape T has been wound, the servo motor 56 is activated again by the servo unit 58, and the ball thread 54 is rotated in the opposite direction to that described above. The support member 52 threaded onto the ball thread 54 moves in the opposite direction to that described above, and the position of the rotation drive motor 46 is displaced in the opposite direction to that described above, with the position of the recording tape T displacing in the width direction (in the axial direction of the reel hub 32) in the opposite direction to that described above.

For example as shown by the double dot broken lines in FIG. 2, when the reel 30 moves (displaces) to the lower case 16 side (upward in the drawing), the winding position of the recording tape T is relatively positioned offset toward the upper flange 34 side, and the recording tape T is wound with the edge of the recording tape T being immediately adjacent to (just prior to contact with) the inner face 34A of the upper flange 34, or it is slightly in contact therewith. Note that the position of the rotation drive motor 46 at this time is detected by the displacement sensor 60.

Then, while in this state, when it is determined by the non-illustrated control device that a specific length of the recording tape T has been wound, namely up to the end of winding (for example 50 m or more), rotation of the rotation drive motor 46 is stopped, the recording tape T is cut, and the leader pin 20 is attached to the free end portion of the recording tape T, and the leader pin 20 is retained by the pin retaining portions 26. The winding process of the recording tape T onto the reel 30 is thereby completed.

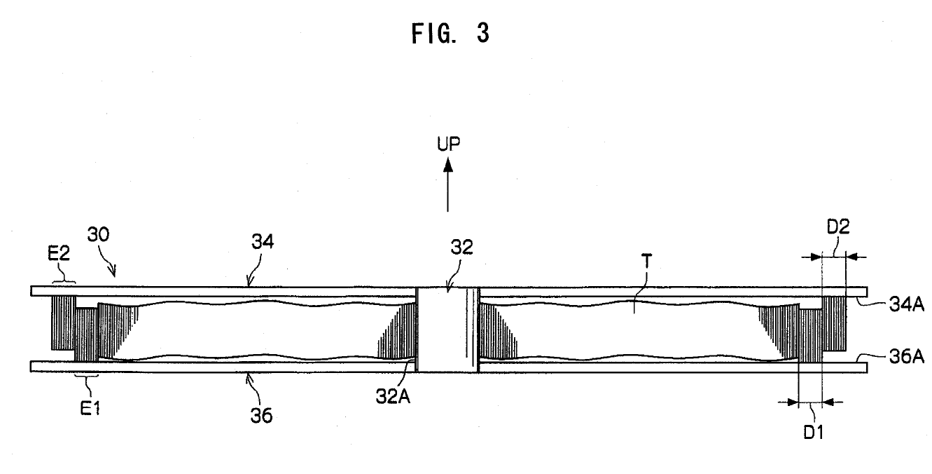

FIG. 3 shows schematic sectional view of the reel 30 on which the recording tape T is wound. The reel 30 in FIG. 3 is shown inverted in comparison to the reel 30 shown in FIG. 2. The normal state is shown in FIG. 3 in which the upper flange 34 is at the top side, and the lower flange 36 is at the lower side. As shown in FIG. 3, at the radial direction outside (the outermost peripheral side) of the recording tape T which was wound on the reel hub 32, formed, in sequence from an inner side in a radial direction of the reel 30 are: a first region E1, positioned offset toward the lower flange 36 side (only slightly in contact with, or immediately adjacent to, the inner face 36A of the lower flange 36); and a second region E2, positioned offset toward the upper flange 34 side (only slightly in contact with, or immediately adjacent to, the inner face 34A of the upper flange 34).

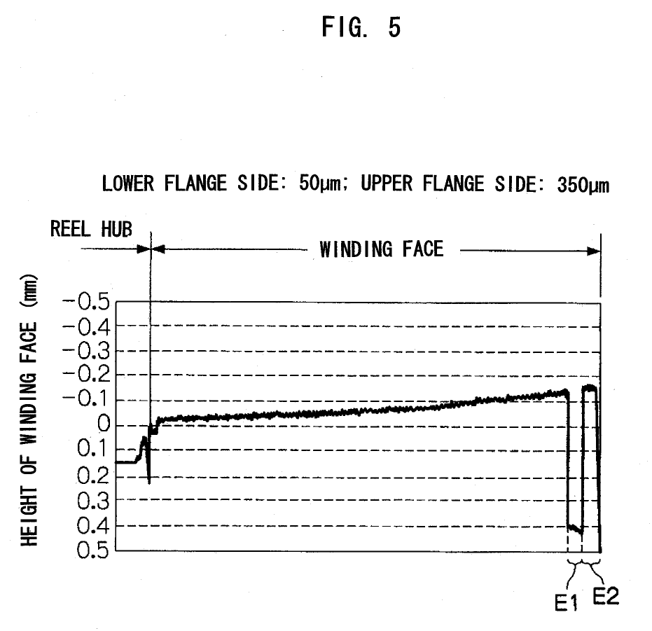

A winding face is formed with every widthwise end of the wound recording tape T at both the upper flange 34 side and the lower flange 36 side. The winding face at the upper flange 34 side including the first region E1 and the second region E2 as shown in FIG. 3 is indicated, for example, in FIG. 5. FIG. 5 shows the measuring results of tape winding face of the upper flange 34 side by a laser displacement measure (not illustrated). Namely, the results of measuring the position of the height in the reel hub 32 axial direction of the edge portion of the wound tape at the upper flange 34 side is indicated. The edge portion of the wound tape is measured along the reel radial direction. The left hand side of the graph is equivalent to the portion where the winding face meets the reel hub 32, and the right hand side of the graph is equivalent to the outermost peripheral portion of the winding face. A line indicates variation in the reel hub axial direction of the winding face.

Explanation will now be given of the results of actual drop tests on the recording tape cartridge 10. The drop tests are in accordance with the drop test method specified in the test conditions of the International Safe Transit Association (ISTA)—1A, with drop locations of 1 corner, 3 edges, and 6 faces of the case 12 using a drop height of 76 cm. The recorded acceleration imparted to the recording tape cartridge 10 when dropped is about 180 G (G being the acceleration due to gravity).

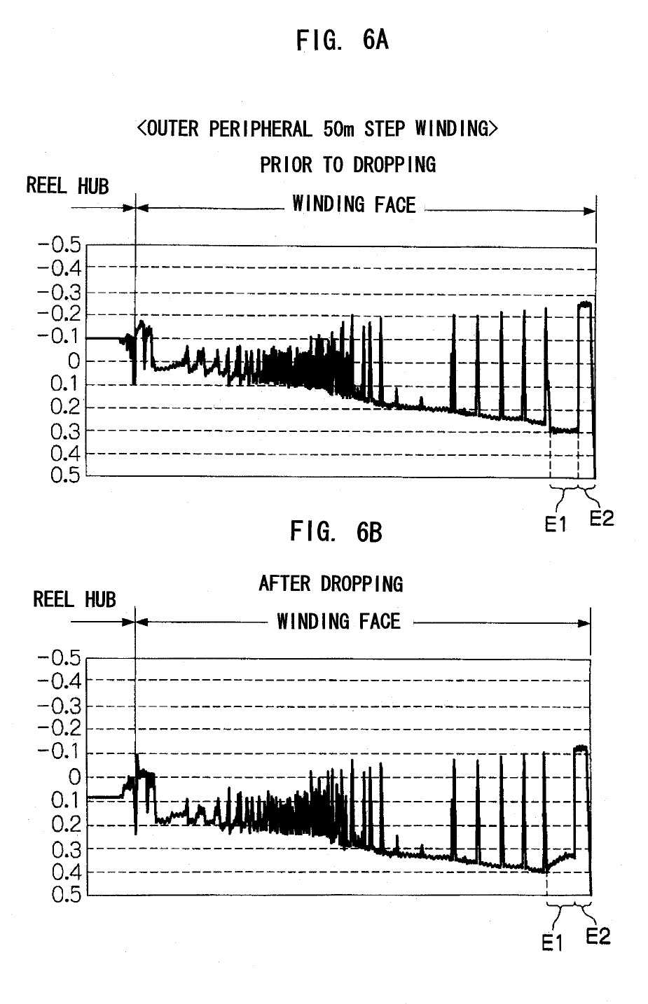

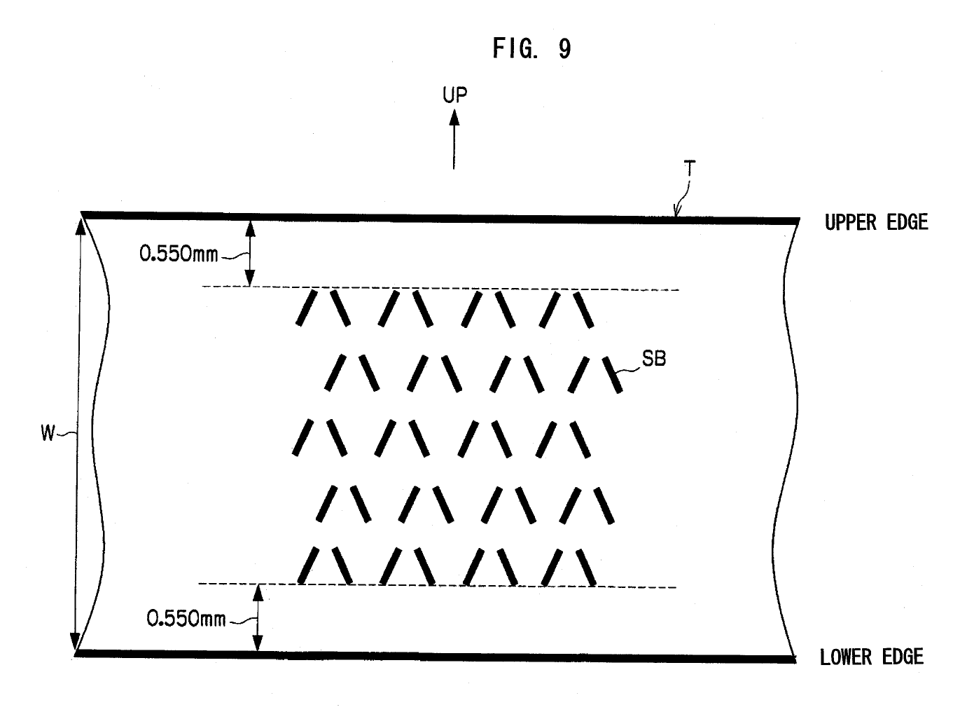

In the drop tests, the outer diameter of the reel hub 32 of the reel 30 is 44 mm, and the total length of the recording tape T wound thereon is 820 mm. The width W of the recording tape T (see FIG. 9) is 12.65 mm, and the thickness thereof is 6.6 μm. The winding face including the first region E1 and the second region E2 at the upper flange 34 side, shown in FIG. 3, is deliberately formed with irregular winding. The state of the winding face at the upper flange 34 side is measured with the laser displacement measure (not illustrated) in the same manner as that of FIG. 5. As shown in FIG. 6A, one-layer sticking out of the recording tape T is deliberately formed at plural locations at the winding face at the upper flange 34 side of the recording tape cartridge 10.

Test results according to the above conditions are shown in FIG. 6B, from dropping the recording tape cartridge 10 provided with the reel 30 with tape of such irregular winding. As shown in FIG. 6B, there is no change in the height in the axial direction of the second region E2 after dropping, and the second region E2 has not become lower than the wound recording tape T on the radial direction inside of the second region E2. Accordingly, the impact (shaking) imparted to the upper flange 34 by dropping is absorbed and suppressed by the second region E2.

Consequently, the recording tape T wound at the radial direction inside of the second region E2 (including the first region E1) does not make contact with the inner face 34A of the upper flange 34, so that occurrences of edge-folding of the recording tape T can be avoided. Namely, even when a shock of a specific amount or greater is imparted, by dropping, to the reel 30 whose winding face has irregular winding (in the state with one layer, or plural layers, sticking out therefrom), edge damage to the recording tape T can be avoided.

Since edge damage does not occur to the recording tape T, errors can also be avoided in which the recording/reproduction head (not shown in the drawings) of the drive device is unable to pick up the servo-band SB (see FIG. 9) formed to the recording tape T.

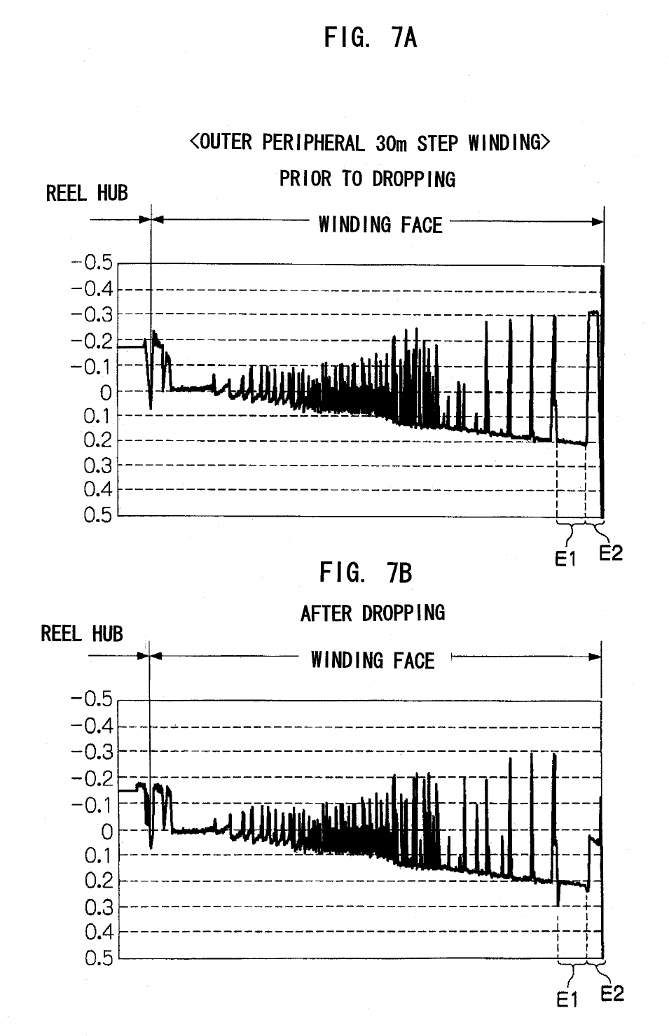

When the thickness of the recording tape T is 6.6 μm, each of the first region E1 and the second region E2 is preferably formed here by winding 50 m or greater (at least 50 m) of recording tape T. FIGS. 7A and 7B shows the fluctuations in the winding face in a comparative example in which a reel 30 formed with first region E1 and second region E2. Each region of E1 and E2 is made by winding 30 m of recording tape T. Similar to FIG. 6A, one-layer sticking out of the recording tape T is deliberately formed at plural locations. A recording tape cartridge having the reel 30 as shown in FIG. 7A is dropped under the same test conditions as above.

As shown in FIGS. 7A and 7B, when the first region E1 and the second region E2 are each formed by winding with 30 m of recording tape T, due to dropping, the height in the reel hub axial direction of the tape edge in the second region E2 becomes less than the height in the reel hub axial direction of the recording tape T (including one-layer sticking out) wound at the radial direction inside of the second region E2 (including the first region E1).

Accordingly, a portion of the impact (shaking) imparted to the upper flange 34 by dropping is absorbed and suppressed by the second region E2, but there is a possibility of edge damage occurring to the recording tape T wound to the radial direction inside of the second region E2 (including the first region E1).

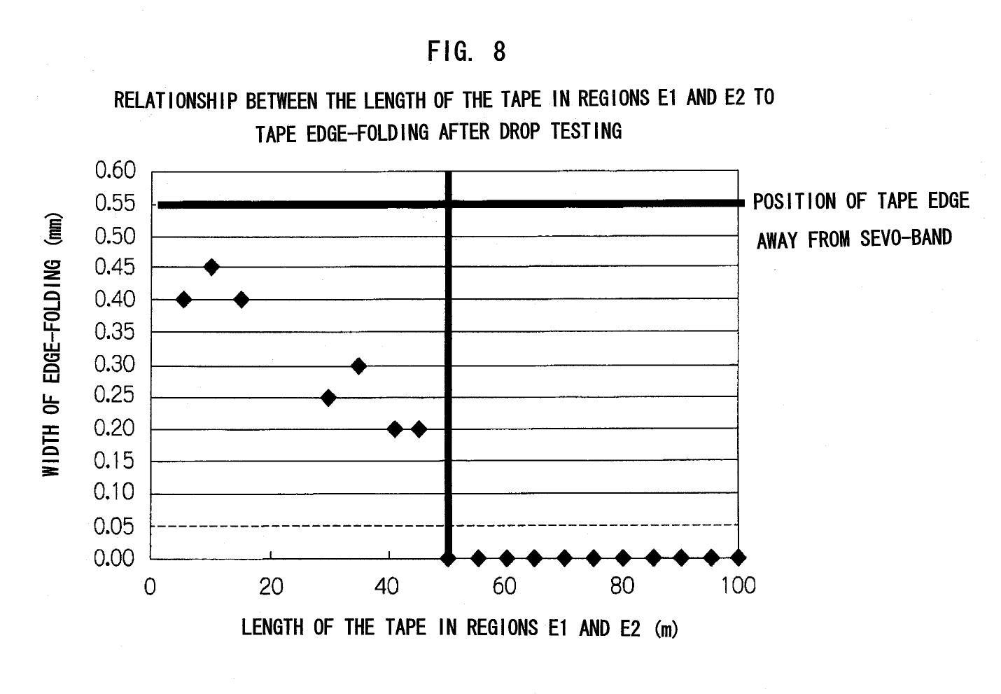

FIG. 8 shows the state of edge-folding as visually observed during the above drop tests when the length of 6.6 μm thickness recording tape T wound in each of the first region E1 and the second region E2 is increased by 5 m intervals. It can be seen that edge-folding (edge damage) to the recording tape T does not occur when the first region E1 and the second region E2 are each formed by winding 50 m or more of 6.6 μm thickness recording tape T.

Consequently, in the case of 6.6 μm thickness recording tape T, it is preferable to wind recording tape T of 50 m or more (at least 50 m) for both the first region E1 and the second region E2, respectively. The relationship between the winding length of the 6.6 μm thickness recording tape T and the radial direction width of the first region E1 and the second region E2 is shown in Table 1. It can be seem from this table that when the thickness of the recording tape T is 6.6 μm, it is preferable to make the radial direction widths D1, D2 shown in FIG. 3 0.86 mm or greater (at least 0.86 mm).

| | First Region E1 and | First Region | Second Region |
|---|---|---|---|
| No. | Second Region E2 | Width D1 | Width D2 |
| 1 | 100 m | 1.95 mm | 1.73 mm |
| 2 | 95 m | 1.84 mm | 1.67 mm |
| 3 | 90 m | 1.73 mm | 1.58 mm |
| 4 | 85 m | 1.62 mm | 1.49 mm |
| 5 | 80 m | 1.51 mm | 1.40 mm |
| 6 | 75 m | 1.41 mm | 1.31 mm |
| 7 | 70 m | 1.30 mm | 1.22 mm |
| 8 | 65 m | 1.20 mm | 1.13 mm |
| 9 | 60 m | 1.10 mm | 1.04 mm |
| 10 | 55 m | 1.00 mm | 0.95 mm |
| 11 | 50 m | 0.90 mm | 0.86 mm |
| 12 | 45 m | 0.81 mm | 0.77 mm |
| 13 | 40 m | 0.71 mm | 0.69 mm |
| 14 | 35 m | 0.62 mm | 0.60 mm |
| 15 | 30 m | 0.53 mm | 0.51 mm |
| 16 | 25 m | 0.44 mm | 0.43 mm |
| 17 | 20 m | 0.35 mm | 0.34 mm |
| 18 | 15 m | 0.26 mm | 0.25 mm |
| 19 | 10 m | 0.17 mm | 0.17 mm |
| 20 | 5 m | 0.08 mm | 0.08 mm |

Note that these test results are for cases where the thickness of the recording tape T has a thickness of 6.6 μm which is thinner than conventionally in order to increase the recording density of the recording tape T. When the thickness of the recording tape T is changed (when the thickness of the recording tape T is not 6.6 μm) then the length of the recording tape T, namely the radial direction widths D1, D2, also changes accordingly.

The length of the recording tape T up to the start of the first region E1 may be selected appropriately, in consideration of the total length of the recording tape T wound on the reel being 820 m, and the remaining length of recording tape T for forming the first region E1 and the second region E2 being 100 m (=50 m×2) or greater (the radial direction widths D1, D2 each being 0.86 mm or greater).

When the rigidities of the upper flange 34 and the lower flange 36 differ from each other, the movement amounts (displacement amounts) of the rotation drive gear 44 toward the upper flange 34 side and toward the lower flange 36 side are preferably made different to each other. If the lower flange 36 is integrally formed to the reel hub 32 and the upper flange 34 is welded to the reel hub 32, then as shown in FIG. 10, the rigidity of the lower flange 36 is greater than the rigidity of the upper flange 34 (in the present example about twice as rigid).

FIG. 10 shows measurements taken of the deformation amount (warping amount) when a load is applied to the outer peripheral edge portion of the upper and lower flanges 34, 36 with the reel 30 fixed in order to compare the rigidities of the upper and lower flanges 34, 36. In such a reel in which the lower flange 36 is integrally formed to the reel hub 32 and the upper flange 34 is welded to the reel hub 32, preferably the movement amount (displacement amount) of the rotation drive motor 46 (reel hub 32) when positioning offset toward the upper flange 34 side is set greater than the movement amount (displacement amount) of the rotation drive motor 46 (reel hub 32) when positioning offset toward the lower flange 36 side.

Generally, due to curvature of the recording tape T or the like, the edge of the recording tape T makes contact with the inner face of the flange, and when wound with a winding tension, flanges tend to deform outwards as the flange inner face is pressed by a force applied with the edge of the recording tape T. This effect is particularly significant at the smaller rigidity flange side. Therefore when positioning the recording tape T offset toward the less rigid upper flange 34 side, if the movement amount (displacement amount) of the rotation drive motor 46 (reel hub 32) is not sufficient, then the edge of the recording tape T can not reach the inner face 34A of the upper flange 34, and sometimes the second region E2 cannot be formed.

It is therefore preferable to control the servo motor 56 with the servo unit 58 such that when positioning the recording tape T offset toward the less rigid upper flange 34 side, the movement amount (displacement amount) of the rotation drive motor 46 (reel hub 32) is set to be greater than the movement amount (displacement amount) of the rotation drive motor 46 (reel hub 32) when positioning the recording tape T offset toward the more rigid lower flange 36 side.

However, if the movement amount (displacement amount) of the drive device 40 when positioning the recording tape T offset toward each of the upper and lower flange 34, 36 sides is too great, then the recording tape T contacts the inner face of the flange, and bounces back, leading to occurrences of one layer, or plural layers, sticking out toward the opposite side.

Therefore, it is preferable to position the recording tape T respectively offset toward the lower flange 36 side and the upper flange 34 side by an amount such that the first region E1 and the second region E2 can be formed, or in other words such that the recording tape T in the first region E1 and the second region E2 is only slightly in contact with (barely contacting with), or is just adjacent to (scarcely not contacting with), the inner face 36A of the lower flange 36 and the inner face 34A of the upper flange 34, respectively.

More specifically, as shown in FIG. 5, in terms of numerical values, when positioning the recording tape T offset toward the lower flange 36 side having larger rigidity in the present example, the movement amount (displacement amount) of the rotation drive motor 46 is preferably set with a maximum of 50 μm, and when positioning the recording tape T offset toward the upper flange 34 side having smaller rigidity, the movement amount (displacement amount) of the rotation drive motor 46 is preferably set with a maximum of 350 μm.

Explanation will now be given of a case in which both edges of the recording tape T in the width direction are not parallel, namely the recording tape T is curved at both width direction edges. When the recording tape T is laid out naturally on a flat surface with no tension applied along the length direction, if there is a radius of curvature in which the peripheral length along either the top edge or the bottom edge is shorter than that along the other edge, then generally the recording tape T has a tendency to be wound while moving toward a direction where the short peripheral length side is positioned. Take the case of a minus curvature recording tape T (a case of recording tape T in a state in which when the recording tape T is laid out naturally on a flat surface with no tension applied along the length direction, the recording tape T has a radius of curvature with the peripheral length along the top edge shorter than that along the bottom edge), and of winding the above recording tape T on the reel 30 in which the lower flange 36 is integrally formed to the reel hub 32 and the upper flange 34 is welded to the reel hub 32. Here the rigidity of the lower flange 36 is larger than the rigidity of the upper flange 34, as shown in FIG. 10. Then, the winding face readily moves towards the low rigidity upper flange 34 side since the top edge has shorter peripheral length side than the bottom edge is located at the upper flange 34 side. An option is to increase the movement amount (displacement amount) of the rotation drive motor 46 when positioning the recording tape T offset toward the lower flange 36 side by 100 μm so as to compensate the moving of the tape toward the upper flange 34 side when being wound in comparison to FIG. 5 (a case where the two width direction edges of the recording tape T are practically parallel to each other). The movement amount (displacement amount) of the rotation drive motor 46 when positioning the recording tape T offset toward upper flange 34 side is unchanged at 350 μm.

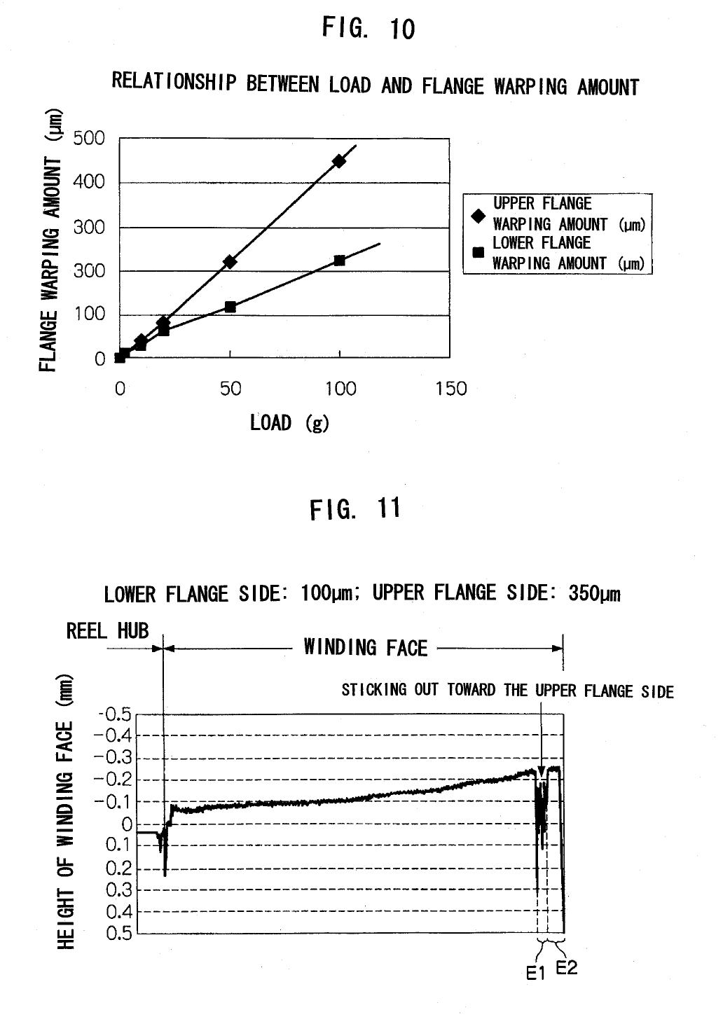

However, in such a case, if the movement amount (offset positioning amount) of the recording tape T toward the lower flange 36 side is too great, then the recording tape T in the first region E1 contacts the inner face 36A of the lower flange 36 and bounces back, leading to the recording tape T sticking out from the upper flange 34 side as shown in FIG. 11. In other words, the first region E1 can not be formed with the edges of the recording tape T aligned with each other.

In the case of a plus curvature recording tape T (a case recording tape T in a state in which when the recording tape T is laid out naturally on a flat surface with no tension applied along the length direction, the recording tape T has a radius of curvature with the peripheral length along the top edge longer than that along the bottom edge), since the winding face readily moves towards the greater rigidity lower flange 36 side, an option is to leave the movement amount (displacement amount) of the rotation drive motor 46 when positioning the recording tape T offset toward the lower flange 36 side unchanged at 50 μm, and to increase the movement amount (displacement amount) of the rotation drive motor 46 when positioning the recording tape T offset toward upper flange 34 side to 400 μm so as to compensate the moving of the tape toward the lower flange 36 side when being wound.

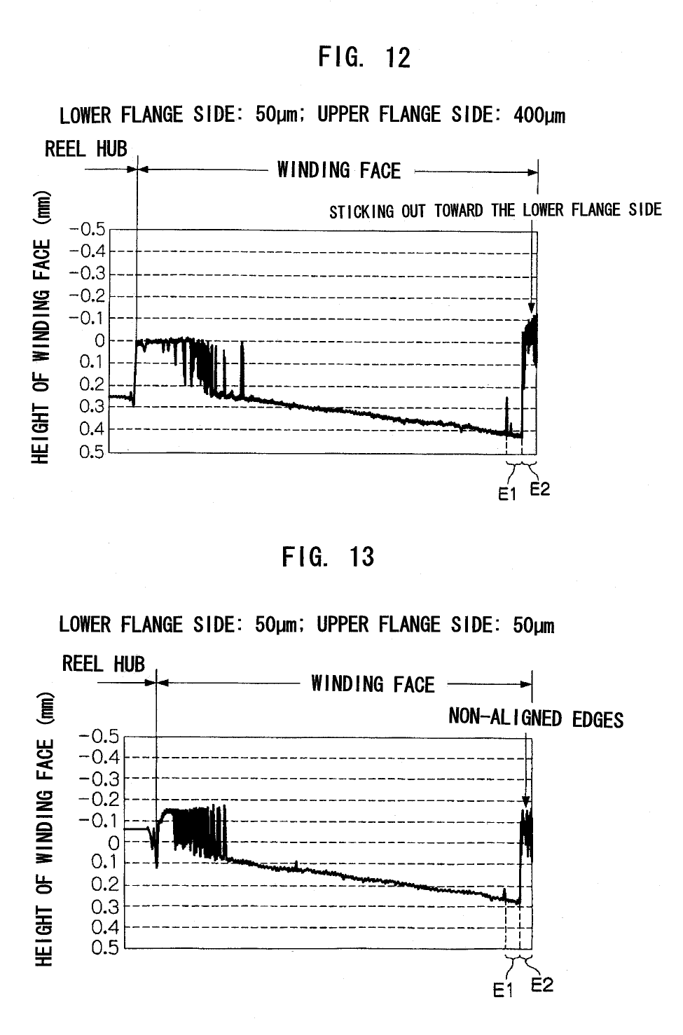

However, in such a case, if the movement amount (offset positioning amount) of the recording tape T toward the upper flange 34 side is too great, then the recording tape T in the second region E2 contacts the inner face 34A of the upper flange 34 and bounces back, leading to the recording tape T sticking out from the lower flange 36 side as shown in FIG. 12. In other words, the second region E2 can not be formed with the edges of the recording tape T aligned with each other.

In the case of a plus curvature recording tape T, for example as shown in FIG. 13, if the movement amount (displacement amount) of the rotation drive motor 46 when positioning the recording tape T offset toward the lower flange 36 side is left unchanged at 50 μm, and the movement amount (displacement amount) of the rotation drive motor 46 when positioning the recording tape T offset toward upper flange 34 side is decreased to also be 50 μm, then since the movement amount (offset positioning amount) toward the upper flange 34 is now too small, similarly the second region E2 can not be formed in the recording tape T with the edges of the recording tape T aligned with each other

Consequently, in the case of both minus curvature and plus curvature recording tapes T, the movement amount (displacement amount) of the rotation drive motor 46 when positioning the recording tape T offset toward the lower flange 36 side is preferably set at a maximum of 50 μm and the movement amount (displacement amount) of the rotation drive motor 46 when positioning the recording tape T offset toward the upper flange 34 side is preferably set at a maximum of 350 μm. The first region E1 and the second region E2 can thereby be formed with the recording tape T edges aligned with each other, and furthermore occurrences of one layer, or plural layers, of the recording tape T sticking out can be suppressed or prevented.

Note that obviously if the upper flange 34 is integrally formed to the reel hub 32, and the lower flange 36 is welded to the reel hub 32, namely in cases where the rigidity of the upper flange 34 is larger than the lower flange 36, then the offset positioning amounts of the recording tape T towards the upper and lower flanges 34, 36 become the reverse to those of the above explanation. Thus the movement amount (displacement amount) of the rotation drive motor 46 when positioning the recording tape T offset toward the lower flange 36 side is preferably set at a maximum of 350 μm and the movement amount (displacement amount) of the rotation drive motor 46 when positioning the recording tape T offset toward the upper flange 34 side is preferably set at a maximum of 50 μm.

Also, in the present exemplary embodiment, regarding the winding shape of the recording tape T, any suitable winding shape may be adopted before the first region E1 is formed as long as control is made such that the first region E1 and the second region E2 are formed at the outmost peripheral side (radial direction outside) of the reel hub 32. Up until starting forming the first region E1, the recording tape T can be wound at the maximum speed of the rotation drive motor 46.

However, when the first region E1 and the second region E2 are being formed, the rotational speed of the rotation drive motor 46 is preferably a speed reduced by a specific amount from the rotation speed prior to starting forming the first region E1, so that the first region E1 and the second region E2 can be more accurately formed. Consequently, there is no significant change to the current manufacturing cycle time when winding the recording tape T on the reel 30.

Even when the recording tape T is moved in the width direction thereof, since the position of the guide roller 48 is fixed, the recording tape T is guided along one of the flanges 48A, 48B of the guide roller 48 when the first region E1 and the second region E2 are being formed. Accordingly, the first region E1 and the second region E2 can be formed even with curved recording tape T (plus curvature or minus curvature) due to the action of the guide roller 48.

As explained above, at the outermost peripheral side (radial direction outside) of recording tape T wound on the reel hub 32, by respectively forming in sequence from the radial direction inner side of the reel 30 the first region E1 in which the recording tape T is positioned offset toward the lower flange 36 (first flange) side, and the second region E2 in which the recording tape T is positioned offset to toward the upper flange 34 (second flange) side, even if the reel 30 is imparted with an impact (shaking) during transportation or when dropped, the warping of the upper flange 34 and the lower flange 36 can be suppressed (absorbed) by the first region E1 and the second region E2.

Consequently, for example, even if there is one layer (or plural layers) of the recording tape T sticking out from the winding face at the radial direction inside of the first region E1 (even if there is irregular winding), then the edges of the sticking out recording tape T do not contact the upper flange 34 or the lower flange 36, or even supposing they were to make contact, it is only a slight contact, and so there is no edge folding. Therefore errors are prevented where the drive device is unable to pick up the sevo-band SB (see FIG. 9) during data recording or reproduction.

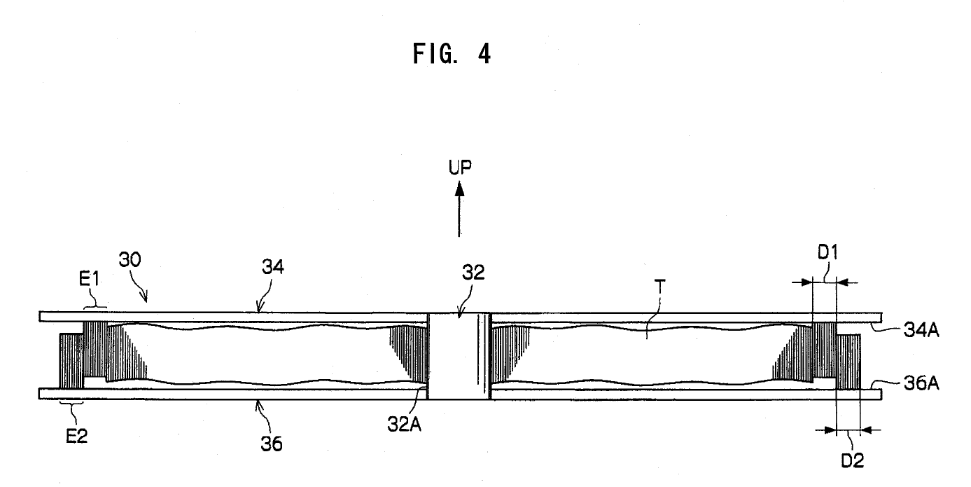

In the reel 30 shown in FIG. 3, the first region E1 is positioned offset toward the lower flange 36 (first flange) side, and the second region E2 is positioned offset toward the upper flange 34 (second flange) side. However, obviously a similar effect can be obtained in a configuration with the first region E1 positioned offset toward the upper flange 34 (first flange) side and the second region E2 positioned offset toward the lower flange 36 (second flange) side, as in the reel 30 shown in FIG. 4.

The first region E1 and the second region E2 serves as the specific region of the present invention, and at least the two regions of the first region E1 and second region E2 should be formed, each offset toward either the upper flange 34 side or the lower flange 36 side. Consequently at the radial direction inside of the first region E1, a further region (not shown in the drawings) may be formed positioned offset toward the opposite side to that of the first region E1, or plural (preferably an even number of) regions may be formed positioned alternately toward the upper flange 34 side and the lower flange 36 side, with all these regions serving as the above specific region.

The reel 30 and the manufacturing method according to the present invention is not limited to the exemplary embodiments shown, and suitable design changes are possible without departing from the scope of the spirit of the present invention. For example, in the above exemplary embodiments the ball thread 54 and the servo motor 56 were employed to move the rotation drive motor 46 in the reel hub 32 axial direction, however there is no limitation thereto, and configuration may be made employing a cam mechanism or cylinder mechanism for moving. In addition configuration may be made with the rotation drive motor 46 fixed, and the reel 30 and the guide roller 48 movable in the axial direction of the reel hub 32.

Also, for example, the reel 30 of the above exemplary embodiments was wound with recording tape T within the case 12, however there is no limitation thereto and configuration may be appropriately made with the reel 30 being wound with recording tape T when outside of the case 12. In the illustrated recording tape cartridge 10 the door 28 is configured to open and close off the opening 18 by sliding in a straight line along the right wall 12A, however the door 28 may be configured, for example, to open and close-off the opening 18 by sliding along a specific curved arc formed of a substantially circular arc shape in plan view.

What is claimed is:

1. A tape and reel combination comprising:
a hub on which recording tape is wound;
a recording tape wound on the hub;
a first flange provided at one end of the hub; and
a second flange provided at another end of the hub, wherein
a specific region of the recording tape wound on the hub, at the outside in the reel radial direction, is formed with a first region and a second region in sequence from the radial direction inner side of the specific region, and
the recording tape is wound in the first region positioned offset toward the first flange side, and the recording tape is wound in the second region positioned offset toward the second flange side.

2. The tape and reel combination according to claim 1, wherein the recording tape is wound in an offset position such that a widthwise edge of the recording tape is positioned immediately adjacent to the hub-side inner face of the first flange in the first region and another widthwise edge of the recording tape is positioned immediately adjacent to the hub-side inner face of the second flange in the second region.

3. The tape and reel combination according to claim 2, wherein the widthwise edge of the recording tape contacts with the hub-side inner face of the first flange in the first region and the another widthwise edge of the recording tape contacts with the hub-side inner face of the second flange in the second region.

4. A tape and reel combination manufacturing method for a reel with a hub with recording tape wound thereon, the hub being provided with a first flange at one end of the hub and a second flange at another end of the hub, the reel manufacturing method comprising:
rotating the hub;
after a specific amount of recording tape has been wound on the hub, moving the hub in one direction along the rotation axis direction of the hub, so that the recording tape is positioned offset toward the first flange side, and rotating the hub a specific number of rotations to form a first region; and then,
moving the hub in the opposite direction along the rotation axis direction, so that the recording tape is positioned offset toward the second flange side, and rotating the hub a specific number of rotations to form a second region.

5. The tape and reel combination manufacturing method of claim 4, wherein when the rigidity of the first flange and the second flange are different from each other, the movement amount of the hub when positioning the recording tape offset toward the smaller rigidity flange side is greater than the movement amount of the hub when positioning the recording tape offset toward the larger rigidity flange side.

6. The tape and reel combination manufacturing method of claim 4, wherein the rotation speeds of the reel when forming the first region and the second region are slower than the rotation speed of the reel prior to forming the first region.

7. The tape and reel combination manufacturing method of claim 4, wherein the recording tape is wound in an offset position such that a widthwise edge of the recording tape is positioned immediately adjacent to the hub-side inner face of the first flange in the first region and another widthwise edge of the recording tape is positioned immediately adjacent to the hub-side inner face of the second flange in the second region.

8. The tape and reel combination manufacturing method of claim 7, wherein the recording tape is wound in an offset position such that the widthwise edge of the recording tape contacts with the hub-side inner face of the first flange in the first region and the another widthwise edge of the recording tape contacts with the hub-side inner face of the second flange in the second region.
